(19) United States
(12) Patent Application Publication
(10) Pub. No.: US 2003/0197354 A1
(43) Pub. Date: Oct. 23, 2003

(54) Inflatable headliner system

(75) Inventors: William R. Beland, Grand Haven, MI (US); Kirk Meyer, Holland, MI (US)

Correspondence Address: FOLEY & LARDNER, 777 EAST WISCONSIN AVENUE, SUITE 3800, MILWAUKEE, WI, 53202-5308, US

(73) Assignee: Johnson Controls Technology Company

(21) Appl. No.: 10/125,013

(22) Filed: Apr. 18, 2002

(51) Int. Cl. B60R 21/22; B60R 21/04; B60R 21/055

(52) U.S. Cl. 280/730.1; 280/751

(57) ABSTRACT

An inflatable headliner system is mounted below a vehicle roof. It deforms upon an accident/impact toward vehicle occupants. In the preferred embodiment, inflatable portions surround a central section of an inflatable layer. Individual portions may be separated by passageways. If cross bows are employed in the vehicle roof structure, an embodiment utilizes inflatable portions beneath the cross bows.

Cross-reference to related patent application, if any: None.

### BACKGROUND OF THE INVENTION

1. Field of the Invention

The present invention relates generally to the field of vehicle occupant protection systems and more particularly, to those which involve the use of inflatable devices. In particular, the present invention relates to the use of an inflatable headliner system. The system is arranged to inflate upon an accident/impact to deform the headliner downwardly, away from the vehicle roof, and toward the lower portions of the vehicle interior. In the most preferred embodiment, the inflatable headliner system includes a plurality of inflatable portions which extend about its perimeter, and additional inflatable portions cross transversely in the event cross bows are included in the vehicle roof.

2. Description of the Prior Art

A large number of air bag systems for occupant protection in vehicles are known. These include air bag systems mounted within the steering column, instrument panel, and other interior locations to assist occupants in the event of frontal impacts. In recent years, side air bags which may be deployed from the area around the side rail of the vehicle roof have also become popular. Air bags may also be located within the seat for deployment along the side of the vehicle when triggered by side impact sensors or the like.

There is an increasing emphasis on providing impact countermeasures for all parts of an occupant's body, including the head, and countermeasures are currently employed in headliner systems, most of which involve the use of a deformable material (such as a urethane elastomer) located behind the interior or “A” surface of the headliner. Such countermeasures provide varying degrees of protection and also involve several disadvantages from the standpoint of cost, assembly time, and the like. They require so much space in some cases that the vehicle cockpit volume is substantially diminished. While no prior art is known by the present inventors which would result in the integration of an inflatable fabric within a headliner system, the inventors believe that an air cushion urging the headliner system downwardly at the time of an accident/impact would enhance overall occupant protection capabilities in a vehicle. Such an inflatable headliner system would represent a substantial advance in this art.

### FEATURES AND SUMMARY OF THE INVENTION

A primary feature of the present invention is to provide an inflatable system integrated into the headliner of a vehicle.

Another feature of the present invention is to provide an inflatable headliner system which is readily adaptable to a wide variety of vehicle roof structures.

Yet another feature of the present invention is to provide an inflatable headliner system which does not significantly reduce the interior volume of the vehicle cockpit.

A different feature of the present invention is to provide an inflatable headliner system which includes inflatable and, in some cases, non-inflatable portions.

Yet still another feature of the present invention is to provide an inflatable headliner system which eliminates the need for complex, multi-component head impact countermeasure components.

A still further feature of the present invention is to provide inflatable portions around the perimeter of an inflatable headliner system, and in a preferred form to provide air passageways between the inflatable portions.

Another feature of the present invention is to provide inflatable portions which extend transversely of the vehicle where cross bows are used in the vehicle roof.

Another feature of the present invention is to provide an inflatable headliner system in which openings are provided for vehicle accessories such as visors, mirrors, grab handles, coat hooks, sun roofs, and the like.

How the foregoing and other features of the present invention are accomplished individually, collectively, or in various subcombinations, will be described in the following detailed description of the preferred embodiment taken in conjunction with the FIGURE. Generally, however, they are accomplished in an inflatable headliner system which includes an inflatable component integrated into the located as a sandwiched layer between other headliner layers such as structural layers, or convenience layers (e.g. sound absorption layers, cushion layers, etc.). The headliner may include various known laminate or composite layers. The inflatable component preferably includes a thin fabric sheet and a plurality of inflatable and non-noninflatable portions. The inflator(s) for the system may be located in the headers, the side rails or any of the “A”, “B”, “C” or “D” pillars. When a deployment event occurs, the headliner system is deformed urging it downwardly and away from the vehicle roof. In further preferred embodiments, inflatable portions may be separated by air flow passageways, and in vehicles which employ cross bows, additional inflatable portions may be provided beneath them.

Other ways in which the features of the present invention are accomplished will become apparent to those skilled in the art after they have read this specification and are deemed to fall within the scope of the present invention if they fall within the scope of the claims which follow.

### BRIEF DESCRIPTION OF THE DRAWINGS

FIG. 1 is an exploded view of a headliner air bag system according to a preferred embodiment of the invention.

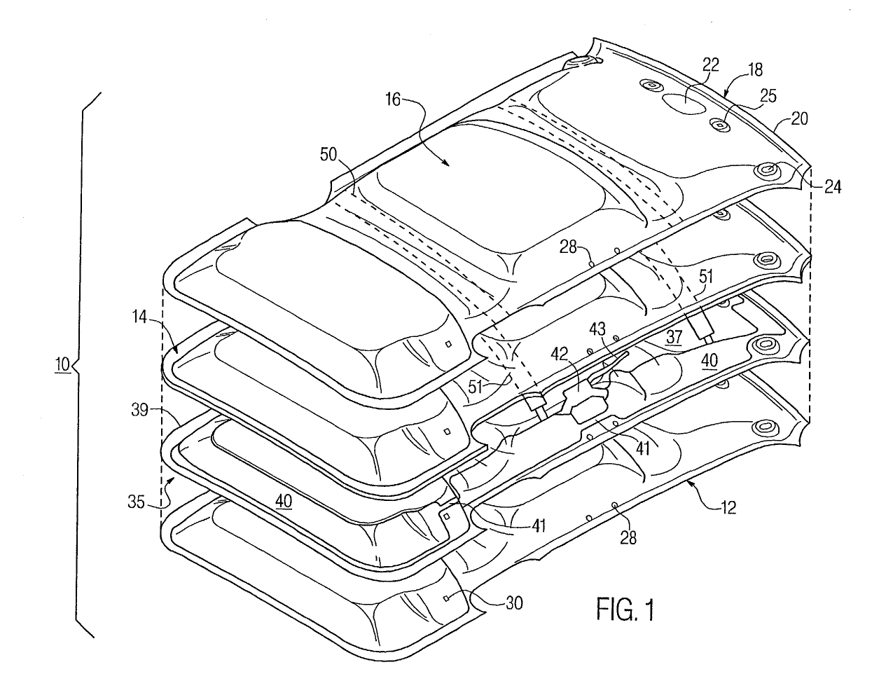

### DETAILED DESCRIPTION OF THE PREFERRED EMBODIMENT

Before proceeding with the description of the preferred embodiment, several general comments can be made about the applicability and the scope thereof.

First, one particular headliner system is illustrated in the FIGURE, namely one having layers of fabric, structural foam, and a reinforcement convenience layer. In addition, a few locations for attachment of vehicle interior accessories are shown, such as visors, a dome light, grab handles, a coat hook, etc. It should be understood at the outset that the present invention has broad applicability to headliner systems for cars, SUV's, vans, light trucks, and other vehicles where an inflatable headliner system can be used to enhance vehicle safety.

In addition to the overall shape and dimensions of the headliner, a wide variety of other openings can be provided through the headliner for the attachment of such other accessories as infotainment devices, air ducts, computer ports, additional lighting, power outlets, sun roofs, etc. It is becoming increasingly important to motor vehicle manufacturers to provide a wide range of passenger accessible components, and overall structural and aesthetic design flexibility is enhanced when the headliner or roof area of a vehicle can be employed.

The present invention is illustrated for use with a layered headliner system which includes an interior fabric layer, an intermediate structural layer, and a convenience layer which abuts the vehicle roof. A large number of different headliner constructions are known in the art, and the present invention can be used with them as well. For example, the fabric and foam layers may be readily combined into a single layer, or more layers of material can be employed, typically in higher end vehicles where a plush feel is desirable.

The present specification illustrates the inflatable portion of the headliner system located between the lowermost two layers of the headliner structure, i.e., between the fabric and a structural layer. Such location is not critical, and the invention would perform its intended function if the inflatable component was located between the structural and the convenience layers. Alternately, the inflatable portion may be the “A” surface layer, or a backside layer.

With regard to the inflatable layer itself, it is illustrated as having a non-inflatable center surrounded by a plurality of inflatable portions, some of which are connected by narrow air flow passageways. Neither a plurality of portions or passageways are required. For example, the inflatable portions could be one sack or bag around the entire periphery (thereby eliminating the air passageways) or a larger number of inflatable portions can be provided than are illustrated. Furthermore, the portions can extend further toward the center of the air bag layer than is shown in the drawings. Moreover, if roof bows are located in the vehicle, inflatable portions can be located beneath them for reasons discussed in greater detail below. Also, the number of ignitors (which are well known in and of themselves and which create a large volume of inert gas, such as nitrogen, at the time a remotely located sensor detects a sudden deceleration or impact) can be variously located within the inflatable headliner system. In the illustration, a single ignitor is illustrated on one side, but a similar ignitor can be located on the opposite side and the number can be variously selected by those familiar with air bag design. Moreover, the ignitor(s) can be located in a variety of areas, e.g., in the “A”, “B”, “C” or “D” pillars of the vehicle, or in the front or rear headers, or in the side rails.

Additionally, it should be made very clear that the illustrated system is shown with each of four layers formed for a particular vehicle (e.g. by thermoforming). The inflatable component can be integrated in a wide variety of locations and shapes.

Finally, the materials used for the construction of the inflatable layer, both the inflatable and non-inflatable portions thereof, can be selected from any of those currently in use for front impact or side impact air bags. The preferred material is a fabric, some of which is formed into pockets. The fabric may be nylon or other natural or synthetic woven or non-woven fabrics.

Proceeding now to the description of the preferred embodiment, the FIGURE illustrates an inflatable headliner system 10 of the type which would be used with an SUV. As mentioned above, system 10 could be configured and dimensioned to be used with cars, SUVs, vans, light trucks, i.e. any vehicle which has a roof and a headliner system located between the roof and vehicle occupants.

The illustrated system 10 is shown to include three conventional headliner layers, namely an inner fabric layer 12, an intermediate structural foam layer 14 and a reinforcement or convenience layer 16. Each layer is formed for structural or aesthetic purposes, as is very well known in the vehicle headliner art. For example, layers 12, 14 and 16 (as well as the inflatable layer to be described layer) can be simultaneously or individually thermoformed (if materials which soften upon the application of heat are used), or they may be laid up, sprayed, molded or constructed using these or other known headliner fabrication methods. The layers 12, 14 and 16, in and of themselves, are well known and further details about them need not be provided here.

The exploded view of the FIGURE shows layers 12, 14, and 16 to be separate from one another, but they could be combined (in various subcombinations) or some of the layers might be eliminated in their entirety or other layers added. All that is really required for the present invention is a layer (which may even be the inflatable layer to be discussed below) which can deform toward the vehicle occupant(s) and away from the vehicle roof at the time inflation and occupant protection is called for.

As far as materials are concerned, the individual layers can be made from fabrics, foams, fibers, molded fiberboard, corrugated paper or plastics, etc. or combinations of the foregoing materials, again as is well known in the art.

Referring again to the FIGURE, a number of openings are formed in each of layers 12, 14 and 16 to illustrate several common vehicle accessories, but not to in any way limit the number, sizes or location of such openings. At the center 18 of the front end 20 of the system 10, an opening 22 is provided for a light or other overhead component (mirror, sun glasses holder, garage door opener, holder, etc.). On either side of the opening 22, two additional openings 24 and 25 are provided for the pivoting and inboard couplers, respectively, for sun visors. A pair of grab handle attachment openings 28 are provided along the sides of each of layers 12, 14 and 16, and finally a coat hook attachment opening 30 is provided in the rear portion of each of the three layers 12, 14 and 16. The accessories are, in and of themselves, very well known and need not be described here.

An inflatable layer 35 is shown in the FIGURE located in the preferred embodiment between fabric layer 12 and structural layer 14. Air bag layer 35 is preferably pliable or thermoformable to allow it to conform to the shapes of the layers on either side of it, and it includes a center portion 37 and a periphery 39. Located about periphery 39 are at least one, and preferably a plurality of, inflatable sacks 40. The inflatable sacks 40 may be connected by air flow passageways 41 if desired, and the number of inflatable sacks 40, their size and precise location can be varied by those skilled in the air bag art after they have read this specification. Inflatable sacks 40 are bladders or pockets which are collapsed until a gas is forced into them at the time deployment and headliner deformation is desired.

Air bag ignition systems themselves are very well known, as are the sensors used to detect a deployment event. Accordingly details will not be provided here. What is shown in the FIGURE is an illustrative ignitor 42 and a wire 43 leading to a sensor (not shown). As stated earlier, the number of ignitors and the location thereof can vary. While in the preferred and illustrated embodiment, the ignitor 42 is shown as part of the inflatable layer 35, one or more of them could be located in the “A”, B″, “C” or “D” pillars of the vehicle, or at any other suitable locations.

One additional feature and embodiment will now be described, i.e. the use of additional inflatable sacks 51 if cross-bows are provided in the vehicle in which system 10 will be used. This is desirable in such vehicles because the roof structure at the location of the cross bows will be sufficiently rigid to allow deforming the inflatable layer 35 downwardly upon the occurrence of a deployment event. Unless cross bows are present, the roof metal of the vehicle may yield, reducing the downwardly directed force of the expanding sacks 51. In the FIGURE, cross bow locations are illustrated by dashed lines 50.

While the present invention has been described in connection with a preferred and an alternate embodiment, it is not to be limited in any sense by such disclosures (size, configuration, relative dimensions, materials, numbers of components, etc.) but it is to be limited solely by the scope of the claims which follow.

What is claimed is:

1. An inflatable headliner system for a vehicle comprising:
an inflatable headliner;
a vehicle roof; and
an inflatable layer integrated with the headliner and arranged to deform the headliner when inflated and urge it downwardly with respect to the vehicle roof.

2. The inflatable headliner system of claim 1, wherein the headliner includes a fabric surface facing the interior of the vehicle.

3. The inflatable headliner system of claim 1, wherein the headliner includes a convenience layer adjoining the vehicle roof and a fabric layer facing the interior of the vehicle, the inflatable layer being located between the convenience layer and the fabric layer.

4. The inflatable headliner system of claim 1, wherein the headliner further includes at least one resilient layer.

5. The inflatable headliner system of claim 3, wherein the headliner further includes at least one resilient layer.

6. The inflatable headliner system of claim 4, wherein the resilient layer is a layer selected from the group consisting of at least one layer of foam, fiber or mixtures of foam and fiber.

7. The inflatable headliner system of claim 1, wherein the inflatable layer comprises a non-inflatable portion and at least one inflatable portion.

8. The inflatable headliner system of claim 7, wherein the non-inflatable portion is a layer of fabric and at least one inflatable portion adjoins the non-inflatable portion.

9. The inflatable headliner system of claim 8, wherein the inflatable portion comprises a plurality of inflatable portion.

10. The inflatable headliner system of claim 9, wherein at least one pair of inflatable portions is coupled by an air flow passageway.

11. The inflatable headliner system of claim 7, wherein the inflatable layer extends substantially over the entire surface of the vehicle headliner, the vehicle includes side rails and front and back headers, and inflatable portions lie adjacent the side rails and headers.

12. The inflatable headliner system of claim 11, wherein the vehicle further includes at least one cross bow extending between the side rails and an inflatable portion lies beneath a cross bow.

13. The inflatable headliner system of claim 1, comprising at least one inflator.

14. The inflatable headliner system of claim 1, wherein at least one inflator for the inflatable layer is located within the vehicle at a location other than between the vehicle roof and the inflatable headliner.

15. The inflatable headliner system of claim 13, wherein at least two inflators are adapted to simultaneously inflate the inflatable headliner system.

16. The inflatable headliner air bag of claim 1, wherein the inflatable headliner is formed to the shape of the vehicle roof.

17. The inflatable headliner system of claim 1, wherein the inflatable layer includes inflatable and non-inflatable portions, and openings are formed in the inflatable headliner system for the attachment of vehicle accessories, and the openings through the inflatable layer are through non-inflatable portions thereof.

18. The inflatable headliner system of claim 17, wherein the accessories are selected from the group consisting of coat hooks, grab handles, and visors.

19. An occupant protection system for a vehicle in which an inflatable headliner, at the time of a deployment event, is deformed toward vehicle occupants, the protection system comprising:
a vehicle roof including at least side rails and front and rear headers;
an inflatable headliner located between the inner surface of the roof and the vehicle interior; and
wherein the inflatable headliner includes an inflatable layer.

20. The occupant protection system of claim 19, wherein the inflatable headliner includes a fabric layer, a resilient layer and a convenience layer, the convenience layer generally adjoining the vehicle roof and wherein the inflatable layer is sandwiched between two of the layers of the headliner.

21. The occupant protection system of claim 19, wherein the inflatable layer includes a non-inflatable center and at least one inflatable portion about its periphery.

22. The deployment system of claim 21, comprising a plurality of inflatable portions.

23. The deployment system of claim 22, wherein at least one pair of inflatable portions are coupled by a passageway.

24. The deployment system of claim 21, wherein the vehicle further includes at least one cross bow extending between the side rails and at least one inflatable portion lies beneath a cross beam.

25. The deployment system of claim 16, wherein the inflatable headliner is formed to the shape of the vehicle roof.

26. The deployment system of claim 1 7, wherein the inflatable layer includes inflatable and non-inflatable portions and openings are formed in the headliner and the airbag for the attachment of vehicle accessories, and the holes through the inflatable layer are through non-inflatable portions thereof.

27. The deployment system of claim 26, wherein the accessories are selected from the group consisting of coat hooks, grab handles, and visors.

28. An inflatable headliner system comprising:
a vehicle having a roof including at least one cross bow;
an inflatable headliner including an inflatable layer having at least one inflatable portion; and
wherein an inflatable portion extends beneath a cross bow.

29. The inflatable headliner system of claim 28, wherein the vehicle includes a pair of side rails and each cross bow extends between the side rails.

30. The inflatable headliner system of claim 28 comprising an inflatable layer integrated into the headliner, the inflatable layer further including a non-inflatable portion, and at least one inflatable portion.

31. A method for enhancing a vehicle occupant's safety in the event of an accident/impact comprising:
providing an inflatable headliner between a vehicle roof and a vehicle cockpit arranged to deform upon an accident/impact; and
inflating the inflatable headliner.

32. The method of claim 28, wherein the inflatable headliner includes a plurality of inflatable portions, and the method comprises the step of simultaneously inflating such portions.

33. The method of claim 31, wherein an inflatable layer is integrated with other headliner layers selected from the group consisting of appearance layers, reinforcement layers, structural layers, convenience layers, and backing layers.
